(19) United States
(12) Patent Application Publication
(10) Pub. No.: US 2007/0168915 A1
(43) Pub. Date: Jul. 19, 2007

(54) Methods and systems to detect business disruptions, determine potential causes of those business disruptions, or both

(75) Inventors: Robert A. Fabbio, Austin, TX (US); Chris K. Immel, Austin, TX (US); Philip J. Rousselle, Austin, TX (US); Timothy L. Smith, Austin, TX (US); Scott R. Williams, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: Cesura, Inc., Austin, TX (US)

(21) Appl. No.: 11/274,636

(22) Filed: Nov. 15, 2005

(51) Int. Cl. G06F 9/44

(52) U.S. Cl. 717/101

(57) ABSTRACT

Multivariate analysis can be performed to determine whether a computing environment is encountering a business disruption (e.g., relatively long end-user response times) or other problem. Cluster analysis (comparing more recent data with a particular cluster of good operating data), predictive modeling, or other suitable multivariate analysis can be used. A probable cause analysis may be performed in conjunction with the multivariate analysis. A probable cause analysis may be used when one or more abnormal instruments, abnormal components, abnormal load patterns, suspicious actions (such as resource provisioning or deprovisioning activities), software or hardware updates or failures, recent changes to the computing environment (component provisioning, change of a control, etc.), or any combination thereof. The probable cause analysis can include ranking potential causes based on likelihood, and such ranking can include statistical analysis, policy violations, recent changes to the computing environment, or any combination thereof.

### RELATED APPLICATION

The present disclosure is related to U.S. patent application Ser. No. ______, entitled “Methods and Systems Regarding Agents Associated With a Computing Environment” by Blok et al. (Attorney Docket No. 1079-P1350), filed concurrently herewith, assigned to the current assignee hereof, and is incorporated herein by reference in its entirety.

1. Field of the Disclosure

The disclosure relates in general to methods and systems to analyze computing environments, and more particularly to methods and systems to detect problems (e.g., business disruptions) associated with computing environments and determine potential causes of those problems.

2. Description of the Related Art

Business disruptions can be very difficult for businesses to prevent or remedy, particularly when a computing environment is involved. A business disruption can result in a poor end-user experience, such as relatively long end-user response times. Computing environments, such as distributed computing environments, may include any number and variety of components used in running different applications that can affect the end-user experience. Many instruments are used to monitor and control the computing system. Univariate analysis can be performed on some or all of the instruments. The univariate analysis typically compares a current reading on each individual instrument, such as a gauge, to an average reading for that instrument. If the current reading is within a predetermined range (e.g., normal operating range), such as +/−2 standard deviations from the average reading, the current reading is considered to be normal. If the current reading is outside the predetermined range, the current reading is considered to be abnormal, and an associated alert is typically generated. While the univariate analysis is easy to implement and widely used, it is too simplistic for a computing environment used for running a plurality of different applications.

Many times, alerts are generated when problems, including those problems that cause poor end-user experience, do not actually exist, which are herein referred to as “false positives.” For example, many end-users may log into the computing environment within a one-hour period in the morning. The logon sequence may use disproportionate levels of some components associated with the computing environment as compared to the rest of the day when logons are less frequent. Alerts may be activated during this relatively high level of logon activity, even though it is typical and does not represent a problem for the computing environment. Such alerts can be an annoyance, or worse, cause human or other valuable resources to be deployed to attend to a situation that is not truly a problem. Turning off some or all of the alerts is unacceptable because an actual problem that could have been detected by an alert may not be detected until after the problem has caused significantly more damage.

At the other end of the spectrum, actual problems may not be detected. Such undetected problems are herein referred to as “false negatives.” For example, end-user experience problems can exist due to one or more problems associated with a computing environment but are not caught by the simplistic univariate analysis on any or all of the individual instruments. Although each instrument may not be outside of the predetermined range (i.e., it is within the normal operating range), the problem may cause the computing environment to not operate optimally. On another occasion, a problem may not be detected until the problem has become so serious that significantly more resources are needed to correct the problem, recover from the problem, or both, than if the problem was detected earlier.

Even if the alerts would operate properly (no false positives or false negatives), each alert does not necessarily indicate the actual cause of the problem. Computing systems, including distributed computing systems, are becoming more complicated, and applications running on those computing systems can create a very complex computing environment such that it may be very difficult for humans to correctly determine the actual cause of a problem. Therefore, individual alerts and the increasing complexity of computing environments can make identification of the actual cause of a problem very difficult to ascertain.

One industry-standard method of coping with false positives and false negatives is to construct complex logical policies. One approach is to identify a variety of conditions and to craft a special set of policies for each of them so that the right policies will be enforced under the right conditions. It is difficult to construct and to maintain these policies when they depend upon if-then logic and product administrator input. Another approach involves the construction of time-based policies. Policy thresholds can be automatically adjusted at regular intervals in order to adapt them to current conditions and the time of day. Automatic thresholds can be constructed using either univariate or multivariate analysis and the data supporting that analysis can apply a time-based filter. For instance, in making a 9:00 am weekday adjustment, such methods may analyze data from similar times on previous days in order to select appropriate thresholds for the present.

Another method of coping with false positives and false negatives is to rely upon a mathematical model to identify abnormality. An empirical model may become invalid when it is scored against operational data that is observed during a time for which conditions are not similar to those over which the input data was collected. Such a model may need to be refreshed. In other words, it can be expected that mathematical models will need to be updated when valid data of a new nature is encountered. The common approach to this challenge is to enable automatic updates wherein the input data for the model is drawn from a sliding time window that always goes back a fixed amount of time in the past. However, this causes valid, possibly rare and valuable, data to be excluded as the sliding window advances. This approach may also cause inadvertent changes to the definition of abnormality.

### BRIEF DESCRIPTION OF THE DRAWINGS

The present invention is illustrated by way of example and not limitation in the accompanying figures, in which the same reference number indicates similar elements in the different figures.

FIG. 1 includes an illustration of a hardware configuration of a computing environment.

FIG. 2 includes an illustration of a hardware configuration of the appliance in FIG. 1.

FIG. 3 includes a process flow diagram for detecting and determining a probable cause of a problem associated with a computing environment.

FIGS. 4 and 5 includes a process flow diagram for detecting a problem associated with a computing environment in accordance with one embodiment.

FIG. 6 includes a process flow diagram for determining a probable cause of a problem associated with a computing environment in accordance with one embodiment.

FIG. 7 includes a table of data collected from a small set of gauges of interest, whose relationships can be used to identify typical operating patterns.

FIGS. 8 through 10 include tables that list probable causes for a problem as detected from the data in FIG. 7, with and without an application usage filter, respectively.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Methods and systems as described herein can be used to more accurately detect business disruptions or other problems and determine potential causes of those business disruptions or other problems associated with an application environment. A business disruption can include a poor end-user experience, which can be quantified using end-user response time or other instruments that can reflect on the end-user experience associated with a computing environment. Poor end-user experience and other business disruptions can negatively affect a business and may result in missed opportunities (e.g., lost revenue or profit), inefficient use of resources (e.g., customers or employees waiting on the computing environment), or other similar effects. The application can be used to operate a web site or other portion of a business. The methods and systems described herein can help to meet the demands of a business, improve end-user experience, compute the health of an application environment, provide other potential benefits, or any combination thereof. The methods and systems described herein can also help to reduce the frequency of business disruptions, the business disruption time period, or a combination thereof.

The health of a computing environment, including its associated components, can be determined using any or all of the following: the availability of the computing environment's associated components, the failure rate of its components, the performance of its components under various levels of activity, and the utilization of the components relative to their capacities.

Exemplary instrumentation can be categorized according to any or all of the following measurement types: availability, failure, performance (such as efficiency and inefficiency), utilization, and load. For example, with respect to availability, components are available or unavailable. A failure rate can be measured for certain available resources. For instance, an available database service can be rated by the percentage of queries that fail. The database service can also be rated by various measures of efficiency, for instance, the percentage of total CPU time spent on activities other than parsing a query or the percentage of sorts that are performed in memory. Metrics of utilization can measure the percentage of component capacity that is consumed. Metrics of utilization may also be specified without reference to capacity, that is, in the form of a rate of performing an activity. In a database, a rate can include an execution rate (statements processed per second), logical read rate (number of logical reads per second), or the like. A load metric may not measure health per se, but it may provide context for another type of metric. A load metric can measure demand placed upon one or more components. An example in the database is the query arrival rate (queries per second) or the call rate. Such examples as described are intended to merely illustrate and not limit ways in which the health of a computing environment can be determined. The health can be reflective of a patent or latent problem.

Multivariate analysis can be performed to determine whether a computing environment or any portion thereof is encountering a problem. In one embodiment, pattern matching using clusters (“cluster analysis”) and deviations from the closest cluster can be performed. In another embodiment, predictive modeling can be used.

In one embodiment of cluster analysis, operating data that includes readings from instruments on components associated with a computing environment can be collected as applications, including a particular application, are running within the computing environment. The operating data may include readings from nearly any set or all the instruments, such as gauges. In one particular embodiment, the operating data that is collected may only include instruments of special interest such as application service-level (“SL”) gauges, which are gauges that generally reflect the state of the application, which can affect end-user experience, as it runs within the computing environment. An example of such application SL gauges can include the response time, request load, request failure rate, or the like. The data can be filtered such that only data that was collected when the computing environment is known or believed to have been operating properly (i.e., no known problems, such as a server failure, exceeding a memory storage limit, routine maintenance, etc.) is included. Such data will be referred to as “good operating data” and reflect typical states when the application is running within the computing environment. The good operating data can be separated into a predetermined number of different sets of clustered operating data (herein, “clusters”). Each cluster can be a multivariate pattern. For instance, a pattern could be high loads and high response times that are typical during a morning logon rush. Another pattern could be the zero loads and zero response times when the computing environment is idling. In a particular embodiment, more recent operating data is compared to the different clusters of good operating data to determine which cluster is closer to the more recent operating data.

After the closer of one or more clusters is determined, the more recent operating data can be compared to the operating data within the closer cluster to determine if the application's behavior is typical or atypical. The application's behavior may affect the end-user experience. In one embodiment, an instrument-by-instrument comparison can be performed after the closer cluster is identified. In a particular embodiment focused on a chosen set of special-interest instruments, a closer pattern for those special-interest instruments among all the typical patterns for the data collected during an interval is identified, and readings from each special-interest gauge are analyzed. Any instrument being analyzed whose current reading is a pattern violation, a policy violation, or both is considered to be an abnormal instrument. One or more instruments can be identified as being abnormal. The instrument(s) that are abnormal can be indicated as such. In many embodiments, the special interest instruments can be gauges; however, the special interest instruments can include one or more controls in additional to or in place of the gauges.

Predictive modeling can also be used. For predictive modeling, predictive models can be built using the good operating data. A more current reading from an instrument can be compared to a predicted reading for the instrument. If the more current reading from the instrument is outside a range for the predicted reading, then the instrument can be considered abnormal and indicated as such.

The multivariate analysis can be beneficial because it is not a simple univariate analysis. The pattern matching, predictive modeling, or other multivariate analysis can address variations associated with a computing environment that are typical. For example, if at least one day's worth of operating data is collected, the logon sequence as previously described would not be identified as atypical even though it may include one or more instrument readings that would be considered to be extreme. Thus, the likelihood of false positives can be significantly reduced. Also, problems with subtle signatures can be detected even if instruments have readings that are not extreme. Thus, the likelihood of false negatives can also be significantly reduced. In this manner, problems are more accurately determined and are determined at an earlier time than when using a simple univariate approach.

A probable cause analysis may be performed in conjunction with the multivariate analysis. A probable cause analysis may reveal one or more abnormal instruments, abnormal components, atypical load patterns, suspicious actions (such as resource provisioning or deprovisioning activities), software or hardware updates or failures, recent changes to the computing environment (component provisioning, change of a control, etc.), or any combination thereof.

In one embodiment, a computing environment may be in an atypical state or otherwise have a problem. The probable cause analysis can include determining that the computing environment is in an atypical state at least in part by using a multivariate analysis. The multivariate analysis can involve a plurality of instruments on the computing environment. The probable cause analysis can also include ranking potential causes of the atypical state in order of likelihood. The ranking can be based on one or more policy violations, one or more recent changes to the computing environment, degrees of abnormality of the instruments, relationships between at least some of the instruments, or any combination thereof. For example, policy violations may be ranked higher than the degrees of abnormality for any of the instruments. Still, the method and system are highly flexible and can be configured to the needs or desires of the business operating the computing environment. Optionally, additional filtering can be performed on one or more criteria. For example, a filter can be based on usage of a component by a particular application. Filtering can be performed such that only those instruments that significantly affect or are significantly affected when a particular application is running within the computing environment are retained in a list, or such that those instruments that are insignificantly affected when the application is running within the computing environment are removed from the list. In one particular embodiment, such additional filtering may be targeted with a focus on the instruments that more strongly affect end-user experience. With the probable cause analysis, the actual cause of a problem can be determined more accurately and can allow resources to be deployed more quickly and efficiently in order to correct the problem.

In one embodiment, the scope of a probable cause analysis can be specified by adjusting the selection of instruments that will be used. For example, the instruments selected may be based on a business's needs or desires. In a particular embodiment, if a business is concerned with end-user experience, instruments related to end-user experience can be selected. In another particular embodiment, another criterion could be used, such as system utilization, up time, revenue, or the like. Different instruments may be used for the different criteria. The analysis can be performed on a set of instruments and actions (intentional or unintentional changes to the computing environment) which can be adjusted. A broader scope of analysis can consider a larger set of potential probable causes. Output filters can be used to specify the scope in accordance with one or more criteria, such as only those instruments related to a particular application, cause, aggregation level, component type, hardware category, operating system, software service category, product category, other suitable division, or any combination thereof.

A few terms are defined or clarified to aid in understanding of the terms as used throughout this specification. The term “abnormal” with respect to an instrument is intended to mean that a reading for that instrument is a pattern violation, a policy violation, or both.

The term “application” is intended to mean a collection of transaction types that serve a particular purpose. For example, a web site storefront can be an application, human resources can be an application, order fulfillment can be an application, etc.

The term “application environment” is intended to mean an application and the application infrastructure used by that application, and one or more end-user components (e.g., client computers) that are accessing the application during any one or more particular points in time or periods of time, if the end-user component(s) are configured to allow data regarding the application's performance on such end-user component(s) to be accessed by the application infrastructure.

The term “application infrastructure” is intended to mean any and all hardware, software, and firmware used by an application. The hardware can include servers and other computers, data storage and other memories, networks, switches and routers, and the like. The software used may include operating systems and other middleware components (e.g., database software, JAVA™ engines, etc.).

The term “averaged,” when referring to a value, is intended to mean an intermediate value between a high value and a low value. For example, an averaged value can be an average, a geometric mean, or a median.

The term “atypical” is an adjective and refers to a pattern violation that has occurred or is occurring.

The term “business disruption” is intended to mean a situation, one or more conditions, or the like that negatively affects a business. For example, a business disruption can occur when an end-user experience, as measured by any one or more quantifiable measures, is negatively impacted. In a particular example, a business disruption may affect the productivity of the end user. In another example, a business disruption can affect performance of the computer environment or any portion thereof (e.g., a system outage).

The term “business disruption time period” is intended to mean a time of a business disruption starting from a time when first becoming aware of the problem, through identification of the problem, through execution of one or more corrective actions, and ending with verification that the problem has been solved.

The term “component” is intended to mean a part associated with a computing environment. Components may be hardware, software, firmware, or virtual components. Many levels of abstraction are possible. For example, a server may be a component of a system, a CPU may be a component of the server, a register may be a component of the CPU, etc. Each of the components may be a part of an application infrastructure, a management infrastructure, or both. For the purposes of this specification, component and resource can be used interchangeably.

The term “degree of abnormality” is intended to mean the magnitude of abnormality, which may or may not be normalized.

The term “computing environment” is intended to mean at least one application environment.

The term “end-user” is intended to mean a person who uses an application environment, other than in an administrative mode.

The term “end-user response time” is intended to mean a time period or its approximation from a point in time an end user device sends a request for information until another point in time when such information is provided to an output portion (e.g., screen, speakers, printer, etc.) of the end user device.

The term “instrument” is intended to mean a gauge or control that can monitor or control at least part of an application infrastructure.

The term “logical component” is intended to mean a collection of the same type of components. For example, a logical component may be a web server farm, and the physical components within that web server farm can be individual web servers.

The term “logical instrument” is intended to mean an instrument that provides a reading reflective of readings from a plurality of other instruments, components, or any combination thereof. In many, but not all instances, a logical instrument reflects readings from physical instruments. However, a logical instrument may reflect readings from other logical instruments, or any combination of physical and logical instruments. For example, a logical instrument may be an average memory access time for a storage network. The average memory access time may be the average of all physical instruments that monitor memory access times for each memory device (e.g., a memory disk) within the storage network.

The term “multivariate analysis” is intended to mean an analysis that uses more than one variable. A multivariate analysis can be performed when taking into account readings from two or more instruments.

The term “normal” with respect to an instrument is intended to mean an instrument reading that is neither a policy violation nor a pattern violation.

The term “ordinary instrument” is intended to mean any instrument that is not a special-interest instrument.

The term “pattern violation” is intended to mean that one or more readings for a set of instruments for a given time or time period is significantly different from a reference set of readings for the same set of instruments. In one embodiment, the reference set of readings for the set of instruments can correspond to a closer or closest typical operating pattern. In another embodiment, the reference set of readings can be generated using predictive modeling.

The term “physical component” is intended to mean a component that can serve a function even if removed from the computing environment. Examples of physical components include hardware, software, and firmware that can be obtained from any one of a variety of commercial sources.

The term “physical instrument” is intended to mean an instrument for monitoring a physical component.

The term “policy violation” is intended to mean an instrument reading that falls outside simple or compound policy thresholds. An example of a simple policy is that readings for a particular Response Time gauge must be less than or equal to one second. An example of a compound policy is that a reading for a particular utilization gauge is to be less than or equal to ten percent or between eighty and ninety percent.

The term “product administrator” is intended to mean a person who performs administrative functions that may include installing, configuring, or maintaining one or more products that detect problems associated with a computing environment. A person can be acting as a product administrator (e.g., internal use) at one time and acting as an end user (e.g., external use) at another time.

The term “special-interest instrument” is intended to mean an instrument or a set of instruments whose data can be collected during one or more known good or believed-to-be-good intervals in order to identify typical operating patterns from that data. Any instrument can be elevated to special-interest status.

The term “system” is intended to mean any single system or sub-system that individually or collection of systems or sub-systems that jointly execute a set, or multiple sets, of instructions to perform one or more functions.

The term “transaction type” is intended to mean a type of task or transaction that an application may perform. For example, information (browse) request and order placement are transactions having different transaction types for a store front application.

The term “typical operating pattern” is intended to mean a tuple of readings or averaged readings for a set of instruments, such that the tuple represents a substantially distinct multivariate behavior as observed using that set of instruments during one or more known good or believed good operational periods.

The term “univariate analysis” is intended to mean an analysis that uses only one variable. A univariate analysis can be performed when taking into account one or more readings from only a single instrument.

As used herein, the terms “comprises,” “comprising,” “includes,” “including,” “has,” “having” and any variations thereof, are intended to cover a nonexclusive inclusion. For example, a method, process, article, or apparatus that comprises a list of elements is not necessarily limited to only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art in which this invention belongs. Although methods, hardware, software, and firmware similar or equivalent to those described herein can be used in the practice or testing of the present invention, suitable methods, hardware, software, and firmware are described below. All publications, patent applications, patents, and other references mentioned herein are incorporated by reference in their entirety. In case of conflict, the present specification, including definitions, will control. In addition, the methods, hardware, software, and firmware and examples are illustrative only and not intended to be limiting.

Unless stated otherwise, components may be bi-directionally or uni-directionally coupled to each other. Coupling should be construed to include direct electrical connections and any one or more of intervening switches, resistors, capacitors, inductors, and the like between any two or more components.

To the extent not described herein, many details regarding specific network, hardware, software, firmware components and acts are conventional and may be found in textbooks and other sources within the computer, information technology, and networking arts.

Before discussing embodiments of the present invention, a non-limiting, exemplary computing environment is described to aid in the understanding the methods later addressed in this specification. After reading this specification, skilled artisans will appreciate that many other computing environments can be used in carrying out embodiments described herein and to list every one would be nearly impossible.

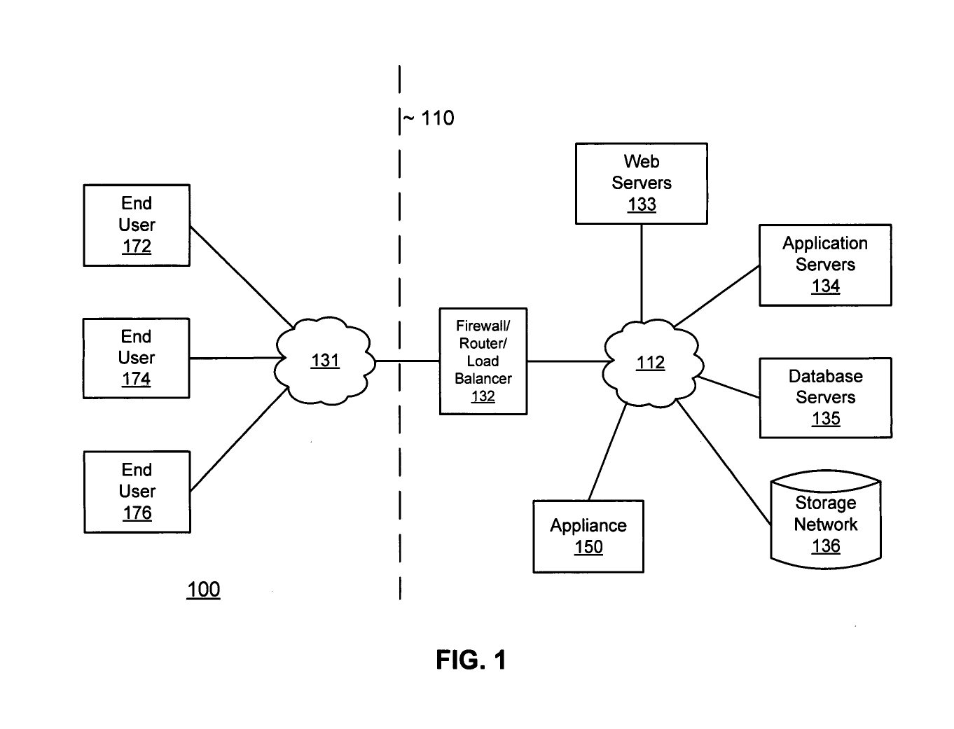

FIG. 1 includes a hardware diagram of a computing environment 100. In one particular embodiment, the computing environment 100 includes a distributed computing environment. The computing environment 100 includes an application infrastructure. The application infrastructure can include those components above and to the right of the dashed line 110 in FIG. 1. More specifically, the application infrastructure includes a router/firewall/load balancer 132, which is coupled to the Internet 131 or other network connection. The application infrastructure further includes a firewall/router/load balancer 132, web servers 133, application servers 134, database servers 135, a storage network, and an appliance 150, all of which are coupled to a public or private network 112. The appliance can include a management server. Other servers may be part of the application infrastructure but are not illustrated in FIG. 1. Each of the servers may correspond to a separate computer or may correspond to a virtual engine running on one or more computers. Note that a computer may include one or more server engines.

The computing environment 100 can also include an external network (e.g., the Internet) and end user devices 172, 174, and 176. Each of the end-user devices 172, 174, and 176 can be configured to access one or more applications running within the application infrastructure. Each of the end-user devices 176 can include a client computer, such as a personal computer, a personal digital assistance, a cellular phone, or the like. Thus, each of the end user devices 172, 174, and 176 can be within the same or different application environments. If data regarding performance of an application cannot be obtained from any one or more of the end-user devices 172, 174, or 176 by the application infrastructure 110, such end-user device(s) may not be considered within the computing environment 100. Whether or not such data can be accessed by the application infrastructure, the end-user devices 172, 174, and 176 are still associated with the computing environment.

Although not illustrated, other additional components may be used in place of or in addition to those components previously described. For example, additional routers may be used, but are not illustrated in FIG. 1.

Software agents may or may not be present on each of the components within the computing environment 100. The software agents can allow the appliance 150 to monitor and control at least a part of any one or more of the components within the computing environment 100. Note that in other embodiments, software agents on components may not be required in order for the appliance 150 to monitor and control the components.

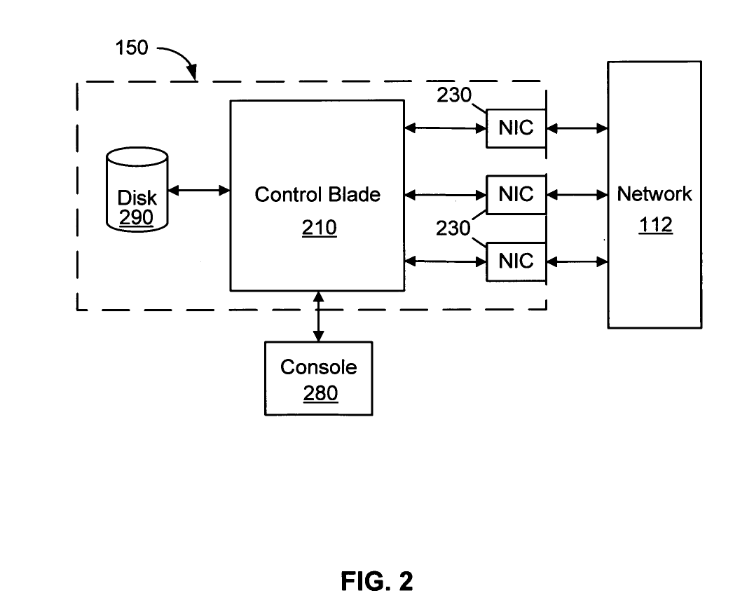

FIG. 2 includes a hardware depiction of the appliance 150 and how it is connected to other components of the computing environment 100. A console 280 and a disk 290 are bi-directionally coupled to a control blade 210 within the appliance 150. The console 280 can allow an operator to communicate with the appliance 150. Disk 290 may include logic and data collected from or used by the control blade 210. The control blade 210 is bi-directionally coupled to one or more Network Interface Cards (NICs) 230.

The management infrastructure can include the appliance 150, network 112, and software agents on the components within the computing environment 100, including the end-user devices 172, 174, and 176. Note that some of the components within the management infrastructure (e.g., network 112, and software agents) may be part of both the application and management infrastructures. In one embodiment, the control blade 210 is part of the management infrastructure but not part of the application infrastructure.

Although not illustrated, other connections and additional memory may be coupled to each of the components within computing environment 100. In still another embodiment, the control blade 210 and NICs 230 may be located outside the appliance 150, and in yet another embodiment, nearly any number of appliances 150 may be bi-directionally coupled to the NICs 230 and under the control of the control blade 210.

Any one or more of the hardware components within the computing environment 100 may include a central processing unit (“CPU”), controller, or other processor. Although not illustrated, other connections and memories (including one or more additional disks substantially similar to disk 290) may reside in or be coupled to any of components within the computing environment 100. Such memories can include content addressable memory, static random access memory, cache, first-in-first-out (“FIFO”), other memories, or any combination thereof. The memories, including disk 290, can include media that can be read by a controller, CPU, or both. Therefore, each of those types of memories includes a data processing system readable medium.

Portions of the methods described herein may be implemented in suitable software code that includes instructions for carrying out the methods. In one embodiment, the instructions may be lines of assembly code or compiled C⁺⁺, Java, or other language code. Part or all of the code may be executed by one or more processors or controllers within one or more of the components within the computing environment 100, including one or more software agent(s) (not illustrated). In another embodiment, the code may be contained on a data storage device, such as a hard disk (e.g., disk 290), magnetic tape, floppy diskette, CD-ROM, optical storage device, storage network (e.g., storage network 136), storage device(s), or other appropriate data processing system readable medium or storage device.

Other architectures may be used. For example, the functions of the appliance 150 may be performed at least in part by another apparatus substantially identical to appliance 150, or by a computer (e.g., console 280). Additionally, a computer program or its software components with such code may be embodied in more than one data processing system readable medium in more than one computer. Note that no one particular component, such as the appliance 150, is required, and functions of any one or more particular components can be incorporated into different parts of the computing environment 100 as illustrated in FIGS. 1 and 2. In addition, the computing environment 100 does not have to be a distributed computing environment. For example, the computing environment 100 can be a computing system that includes one or more processors, memories or other storage devices, I/Os, other suitable computing components, or any combination thereof. In a non-limiting embodiment, the computing environment can include a standalone computer or server having a plurality of processors. Further, functions performed using software may be performed using hardware, functions performed using hardware may be performed using software, or functions performed using just software or just hardware may be performed using a combination of hardware and software.

Attention is now directed to a brief overview of an illustrative method of detecting problems and analyzing potential causes of problems associated with an application running within a computing environment. A data center can be at least part of a computing environment, and a storefront web site application, an inventory management application, and an accounting application are examples of applications. After reading this specification, skilled artisans will appreciate that many other computing environments and applications can be used.

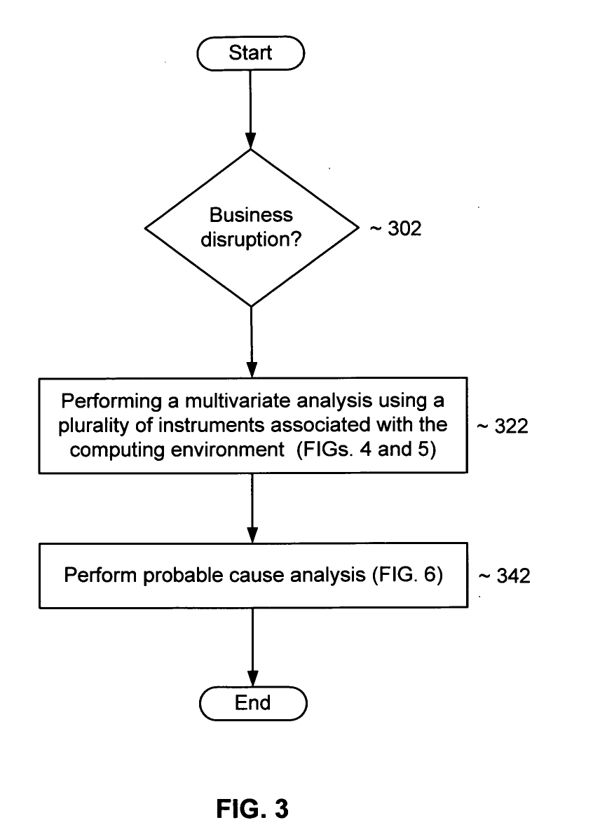

In one embodiment, the method can include determining whether there is a business disruption (diamond 302 in FIG. 3), performing a multivariate analysis using a plurality of instruments on the computing environment (block 322), and performing a probable cause analysis (block 342). After reading this specification, skilled artisans will appreciate that not all of the actions within FIG. 3 need to be performed, could be varied, additional actions could be used, or any combination thereof. Each of the items in FIG. 3 will be described in more detail in the paragraphs that follow.

Regarding diamond 302 in FIG. 3, a business disruption can be nearly anything that negatively affects a business. A business that includes a computing environment, such as a data center, can have degraded performance that can result in poor end-user experience, lost revenue or profit, inefficient use of its other resources, including the business's employees, or a system outage or another failure.

In one embodiment, end-user experience can be determined at least in part using an end-user response time. An end-user may request a web page, file, other data, or any combination thereof. When using a thin net client software service, such as in provided by Citrix Systems, Inc. of Fort Lauderdale, Fla., U.S.A., the end user-response time can include the time when an end-user initiates a send command to request the information (e.g., pressing or activating a “go” or “enter” button or tile) until the requested information appears on the screen of the end-user device. When using a web server using a conventional Internet connection, the time can start with when the web site receives the request until the information is rendered by the browser application on the end-user device. An agent on the end-user's device can collect and transmit the data regarding end-user response time for use with the methods as described herein, when the end-user device is connected to a network, such as the Internet or a proprietary network.

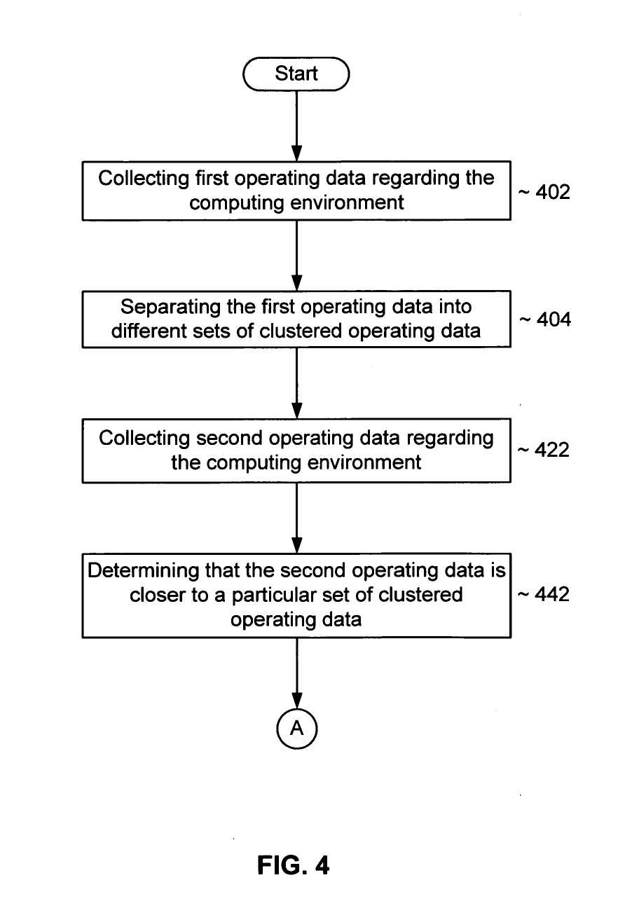

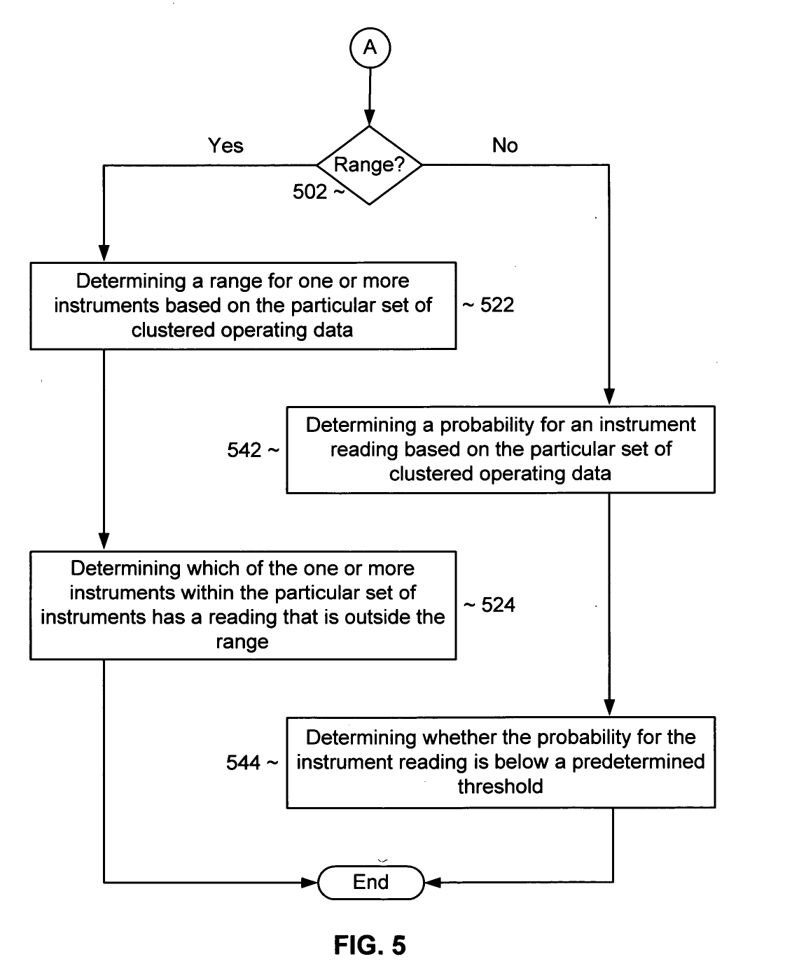

A determination of the business disruption can be performed using a multivariate analysis, which will be described in more detail with respect to FIGS. 4 and 5. For example, an end-user response time can be compared to a demand (e.g., a load rate, such as a request receive rate) and a capacity (e.g., maximum allowable or designed load rate). If the demand is relatively high as compared to the capacity, a relatively longer end-user response time should be expected. Thus, the mere fact that the end-user response time is relatively longer should not necessarily cause an alert to be generated. However, if the demand is relatively low as compared to the capacity, a relatively short end-user response time should be expected.

As an example, during the middle of the afternoon (e.g., 3:00 pm) during a business day, a computing environment may have a relatively high demand compared to its capacity, an end-user response time of approximately 4 seconds may be expected and actually indicate that the computing environment is performing correctly. However, during the middle of the morning (e.g., 3:00 am) on a Sunday, a computing environment may have a relatively low demand compared to its capacity. An end-user response time of approximately 2 seconds may not be expected, as such an end-user response time would be high given the relatively low demand as compared to the capacity of the computing environment. Thus, the computing environment may be performing incorrectly, and an alert should be generated. After reading this specification, skilled artisans will appreciate that determining a business disruption is not as simple as it appears, and that considering a set of variables that can be correlated may provide a more accurate method of determining a business disruption

If a determination regarding a business disruption were to be performed as a univariate analysis using the prior example, an alert regarding end-user response time could be set for 3 seconds. Such a univariate analysis would not consider demand and capacity of the computing environment. Thus, one or more alerts would be common during high periods of traffic and less common during low periods of traffic. In the example, a false positive could occur with the approximately 4 second end-user response time during the middle of the afternoon on a business day, and a false negative could occur with the approximately 2 second end-user response time during early morning on a Sunday.

In another embodiment, the determination action in diamond 302 can be replaced by a different problem or include another problem. The business disruption could include a missed opportunity (e.g., lost revenue or profit), inefficient use of one or more resources, one or more other situations that negatively affects a business, or the like. The business disruption can be performed using a multivariate analysis (e.g., using typical operating patterns, predictive modeling, etc.), a policy violation, a manual process (product administrator observes unusual behavior), one or more other techniques, or any combination thereof. In another embodiment, detection of a business disruption may not be required, as the product administrator may be determining if the computing environment can be operated better (e.g., improved performance, increasing efficiency of components, performing one or more other analyses, or any combination thereof).

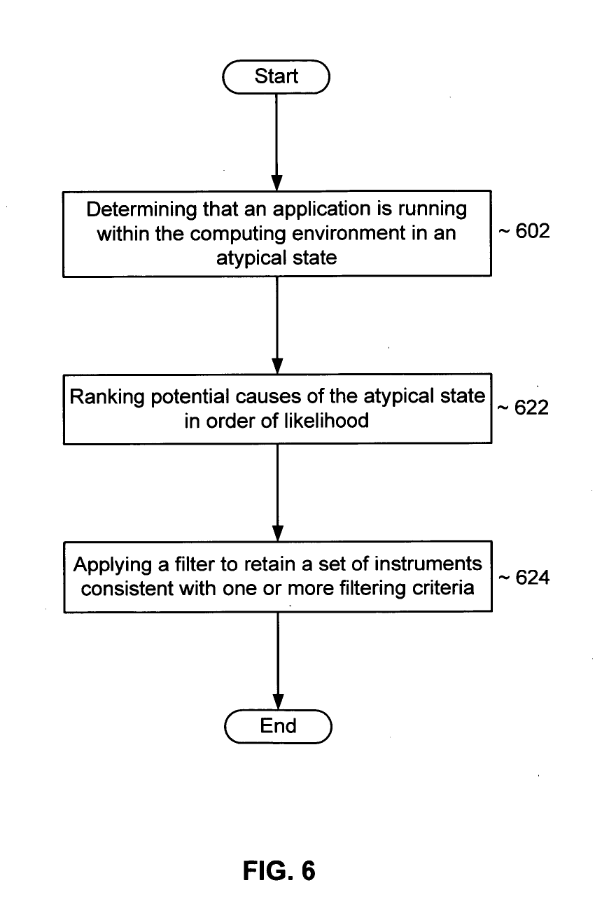

Turning to block 322 of FIG. 3, a multivariate analysis can help to detect problems, including business disruptions. Non-limiting examples of multivariate analyses include cluster analysis and predictive modeling. The cluster analysis is described in more detail with respect to FIGS. 4 and 5. In addition to cluster analysis and statistical predictive modeling, other methods using the good operating data can be built and use any multivariate analysis technique that captures within a mathematical model the ability to identify normal and abnormal instrument readings. The probable cause analysis can be used in analyzing potential causes of a problem. The probable cause analysis (block 342 in FIG. 3) is described in more detail with respect to FIG. 6. Any or all of the multivariate analysis, probable cause analysis, or both can be performed on the appliance 150, on the console 280, another computer, or any combination thereof.

Multivariate analysis using instruments can allow typical operating patterns to be determined more accurately and allow problems to be more accurately detected, thus reducing the number of false positives and false negatives, as compared to a univariate analysis. The instruments can include one or more special-interest instruments using nearly any one or more criteria. For example, a business may be concerned about end-user experience. In one embodiment, the special-interest instruments can include one or more gauges that measure or whose readings reflect (e.g., do not directly measure but significantly affect) end-user experience. The use of multivariate analysis on instruments selected with a focus on one or more business needs or desires can allow a business to operate a computing environment in a manner more consistent with the business's needs or desires. The paragraphs below provide more details on the selection of instruments and collection of data in determining typical operating patterns.

A product administrator can determine which instruments will be special-interest instruments for a particular application running within the computing environment. In one embodiment, the selection can be based in part on a focus of the business operating the computing environment. For example, if the focus of the business is end-user experience, the product administrator may select one or more gauges that measure or whose readings reflect (e.g., do not directly measure but significantly affect) end-user experience. In another embodiment, a business focus could be increasing revenue or profit from a storefront website. The special-interest instruments may be the same or different as compared to the end-user experience. The special-interest instruments may reflect the state of the applications as they run within the computing environment as well as the state of end-users' experience. A non-limiting example of a special-interest instrument can include response time, request load, request failure rate, request throughput or the like. The response time, request load, request failure rate, or any combination thereof may be from the perspective of internal use (e.g., a server computer within the computing environment 100, the console 280 used by a product administrator) or external use (e.g., an end user device 172, 174, 176, or any combination thereof connected via the network 131). In one embodiment, the response time can be end-user response time. More or fewer special-interest instruments can be used. Although not meant to limit, the number of special-interest instruments can be in a range of 1 to 50 instruments, and in one particular embodiment, 3 to 5 instruments can be used. The special-interest instruments may be for different applications on the computing environment, for various metrics of application performance, end-user experience, or for any chosen metrics.

Data can be collected or otherwise obtained for one or more applications running within the computing environment, or both in order to determine typical operating patterns. Such data can include load and one or more metrics that can affect end-user experience. The data can be collected or obtained from a time interval or set of time intervals over which the performance of the computing environment is known or believed to have been good or at least typical. These time intervals can be specified according to the business cycles over which they fall. A full collection of good operating data would include at least a sampling of data from one or more types of business cycles, such as the more important types of business cycles. A collection of good operating data can include at least a sampling of data from the more important types of business cycles. For example, the multivariate analysis which is performed in order to encapsulate within a mathematical model the specification of typical operations could be performed over data which includes samples from one or more typical daily business cycles, one or more holiday business cycles, one or more end-of-quarter business cycles, etc. From samples of typical data, a multivariate cluster analysis can be used to identify a set of typical patterns, each of which is different from the others. Such pattern identification, via clustering, does not need to use time as an input to the mathematical model. In one embodiment, only the identification of patterns is considered, not the particular times or business cycles over which they have previously occurred.

Over a representative set of data, a learning sequence can be performed to determine which instruments significantly affect or are significantly affected by other instruments associated with the computing environments. The instruments can be one or more gauges, or one or more controls, and can include one or more physical instruments (e.g., CPU utilization of a specific processor within a server, average read access time from a specific hard drive, etc.) or one or more logical instruments (e.g., CPU utilization for an entire a web server farm, average read access time for a storage network, etc.). Mathematical descriptions of the relationships between instruments can be determined. Also, a determination can be made which instruments associated with the computing environment significantly affect or are significantly affected by a particular application. Statistical analysis methods can be used to determine significance and the mathematical descriptions of the relationships. U.S. patent application Ser. Nos. 10/755,790 filed Jan. 12, 2004, Ser. No. 10/880,212 filed Jun. 29, 2004, and Ser. No. 10/889,570 filed Jul. 12, 2004, include descriptions of non-limiting exemplary methods for determining significance and the mathematical descriptions.

In addition to statistical analysis, determining which instruments are used by a particular application can include using a product administrator-specified list, configuration information associated with the computing environment, a topology of the network, a deterministic technique, or any combination of statistical or deterministic analysis, product administrator-specified list, a topology of the network, network data regarding a flow, a stream, a connection and its utilization, or configuration information.

The computing environment 100 can run different applications. The priorities of the applications can be the same or different as compared to each other, and the priorities can be changed by a product administrator, temporally (certain hours, periods of a month or quarter calendar, or the like), automatically, based on conditions or criteria being met, or the like.

The method can include accessing first operating data associated with the computing environment as illustrated in block 402 in FIG. 4. As used herein, accessing should be broadly construed and can include collecting the data, reading the data from a file, requesting or receiving the data, or any combination thereof. The first operating data can include first sets of readings from a first set of instruments associated with the computing environment. Any one or more of those instruments may be within one or more of the end-user devices 172, 174, and 176. In a particular embodiment, the first set of instruments can be the special-interest instruments for one or more applications running within the computing environment, and the first operating data can include readings from the first set of instruments when the particular application is running within the computing environment. For example, readings from the first set of instruments can be taken on a periodic basis, such as every each second, half minute, 1, 5, or 10 minutes, or the like. Each set of readings can be stored within a table in the disk 290 or the storage network 136. The number of tuples (sets of readings) can be nearly any number, such as at least 1100, provided they capture a representation of the typical relationships between instruments. For example, in a one-day period, 1440 tuples of data can be collected on one-minute intervals. In one embodiment, the first operating data can include readings from all the special-interest instruments and no others. In another embodiment, the first operating data may include readings from only a fraction of the special-interest instruments (rather than all), at least one other instrument, or any combination thereof.

The amount of data used may include enough data to include tasks performed by an application at a relatively constant rate and tasks performed by the application at a variable rate or periodically. For example, the storefront application may receive requests for web pages at a relatively constant rate during business hours. However, a daily logon rush is relatively high between 8 and 9 am, whereas during the rest of the day, it is relatively low. Still further, the accounting application may be particularly busy just after the end of a month, and particularly, just after a calendar quarter (e.g., three month period). Ideally, operating data collected can reflect a wide array of different but typical operations that the computing environment experiences.

The operating data can be filtered to retain only that operating data when the computing environment is known or believed to be operating in a typical state. Such filtered operating data is an example of good operating data. In one embodiment, data collected when the computing environment has a problem, routine maintenance is being performed, a hardware, software, or firmware upgrade is being installed, or a combination thereof can be considered atypical, and such atypical information may be excluded when later determining typical operating patterns. For the purposes of this specification, removing operating data that was collected during an atypical state is considered the same as retaining only that operating data that was collected when the computing environment, the application, or both are known or believed to be operating in a typical state.

The method can also include separating the first operating data into different sets of clustered operating data, at block 404. In one embodiment, the number of clusters can be determined by a product administrator. While nearly any number of clusters can be used, as the number of clusters becomes too low, the distinction between otherwise different operating patterns may be lost, and if the number of clusters becomes too high, some of the clusters may only include a sparse amount of operating data. In one embodiment, the number of clusters can be in a range of approximately 2 to 200, and in another embodiment, may be in a range of approximately 30 to 50 clusters. The clusters can be groups of tuples having somewhat similar readings. The analysis to determine which tuples belong to which clusters can be performed using a conventional or proprietary statistical technique.

The method can further include accessing second operating data associated with the computing environment, at block 422. The second operating data can include a more recent set of readings (as compared to the good operating data) from the first set of instruments. In one embodiment, the second operating data includes the most recent set of readings from the special-interest instruments. The method can still further include determining that the second operating data is closer to a particular set of clustered operating data as compared to any other of the different sets of clustered operating data, at block 442. In other words, the closest cluster with respect to the second operating data is determined. If the second operating data was collected during a time of high logon activity, it could be compared with good operating data collected during similar times of high logon activity, whose relationships between the special-interest instruments are summarized in a particular typical operating pattern. Such a pattern may include high loads in conjunction with high response times.

In another embodiment, a future business cycle can be defined. For example, a business, such as an on-line retailer, may determine that the number of returns for product sold will be particularly high on December 25 and 26. The business can set the computing environment to collect data during that time period to establish a new typical operating period. The product administrator may set the time period over which data will be collected and can set the computing environment to not generate alerts for readings that come from instruments that are highly correlated with a transaction type of “returns.” Thus, good operating data corresponding to returns can be collected while reducing the number of alerts that may otherwise occur during that time period.

The method can include determining whether a range will be used for one or more subsequent actions (diamond 502 in FIG. 5). When determining whether or not one or more readings from one or more instruments are normal or abnormal, such determination may be based on one or more ranges or one or more probabilities that the reading(s) are normal or abnormal.

If range(s) are used (“Yes” branch from diamond 502), the method can optionally include determining one or more ranges for one or more instruments based on the particular set of clustered operating data at block 522. The particular set of clustered operating data can be the operating data from closest cluster, as determined at block 442. The range can be determined by a variety of methods. In one embodiment, a standard deviation of readings for a particular special-interest instrument within the closest cluster can be determined. The range can be based at least in part on a multiple of standard deviation(s) above, below, or both from an averaged value. For example, the range for a particular special-interest instrument may be the arithmetic average +/− three standard deviations. In another embodiment, the range can be set by the high and low readings for the particular special-interest instrument from the particular cluster of the good operating data. The particular method used for determining the normal range or ranges is not critical, and therefore, other methods for determining the ranges can be used. The limits for the range is an example of a pair of thresholds of abnormality.

The method can also include determining which of the one or more instruments within the first set of instruments has a reading within the second operating data that is outside the limit or limits for the one or more instruments, at block 524. In one embodiment, for a particular special-interest instrument, its most recent reading is compared to the limit(s), as determined in block 522. If the most recent reading is outside the range, the particular special-interest instrument is considered abnormal; otherwise, the particular special-interest instrument is considered normal. If all of the special-interest instruments are normal, the computing environment may be considered as being in a typical state. If any of the special-interest instruments is abnormal, the particular application, computing environment, or both may be considered as being in an atypical state. Because the analysis can be made using a closest cluster, an entity can better perform analysis to determine more accurately whether a problem actually exists. Thus, the number of false negatives and false positives can be substantially reduced.

Probabilities may be used (“No” branch from diamond 502). The method can optionally include determining probabilities for the readings of one or more instruments, based on the particular set of clustered operating data at block 542. The probability can be determined at least in part using the particular set of clustered operating data that can be the operating data from closest cluster, as determined at block 442.

The method can also include determining which of the one or more instruments within the first set of instruments has a reading within the second operating data that is below a threshold probability, which is a particular example of a threshold of abnormality, at block 544. If an instrument reading is below the threshold probability, the instrument can be considered to be abnormal. In one embodiment, for a particular special-interest instrument, the probability of its most recent reading is compared to the threshold probability that delineates abnormality.

In another embodiment, predictive models can be built using the good operating data (see block 402 of FIG. 4). The predictive models can be generated using a conventional or proprietary technique with the good operating data. For example, predictive modeling can include one or more of a wide variety of techniques including neural network modeling, multiple regression, logistic regression, support vector machines, or the like. In this alternative embodiment, clusters do not need to be generated. In one particular embodiment, each special-interest instrument can be considered as being a function of the other special-interest instrument(s). In another embodiment, one or more other instruments can be used in conjunction with or in place of other special-interest instruments. For example, for a particular ordinary instrument, a predictive model can be built where a predicted value for the particular ordinary instrument is a function of all the special-interest instruments. In still another embodiment, a predictive model for a particular instrument may be function of fewer special-interest instruments, some or all of the ordinary instruments, a combination of special-interest and ordinary instruments, or any another combination of instruments. Other predictive inputs may also be included in these models. Examples of other instruments include controls and selected infrastructure instruments.

A more recent reading from an instrument (within the second operating data, block 422 in FIG. 4) can be compared to a predicted reading using the predictive model for the instrument. For a particular instrument being analyzed (e.g., a particular special-interest instrument), if the actual reading of the instrument differs from its predicted reading by more than a threshold amount, the particular instrument is deemed to be abnormal.

Regardless of whether cluster analysis, predictive modeling, or other multivariate analysis is used, the computing environment may be deemed to be in an atypical state if one or more special-interest instruments are abnormal. Alternatively, the computing environment may be deemed to be in a typical state if all special-interest instruments are normal, even though one or more ordinary instruments are abnormal. A pattern violation can occur if a reading for an instrument is outside a range (blocks 522 and 524), below a threshold probability (block 542 and 544), or if predictive modeling or other multivariate analysis indicates that the reading is unlikely to happen when the application is properly running within the computing environment. Any of the multivariate analyses can be used to determine the degree of abnormality associated with any one or more of the readings within the second set of operating data.

Probable cause analysis can be performed at nearly any time regardless of whether any instrument is normal or abnormal, or whether the computing environment is in a typical state or an atypical state. In one embodiment, the probable cause analysis may be automatically performed after a special-interest instrument has two consecutive abnormal readings. In another embodiment, more or fewer abnormal readings may be used to automatically start probable cause analysis. For example, if three of the last four readings from a special-interest instrument are obtained, the probable cause analysis will commence. In another embodiment, the probable cause analysis can be manually started by a product administrator. For example, although all of the special-interest instruments are normal, the product administrator may suspect that something unusual is occurring.

FIG. 6 includes a flow chart for a probable cause analysis that can be performed. The method can include determining that a reading from at least one instrument associated with the computing environment is abnormal, at block 602. In a particular embodiment, such a determination can be part of determining that the computing environment is in an atypical state. In one embodiment, a multivariate analysis can be performed. After reading this specification, skilled artisans can use a different methodology that meets the needs or desires of the product administrator.

The method can also include ranking potential causes of a problem in the computing environment in order of likelihood, at block 622. The problem could be actual or potential (may or may not currently exist, may or may not be imminent, etc.). For example, the problem could be that the end-user experience is poor. More particularly, the end-user response time may be too long given the load and capacity when the end-user response time data was collected. The ranking can be from the most probable to the least probable or vice versa. Many options exist at this point regarding the ranking.

In one embodiment, the ranking can be based on policy violations. A product administrator can also specify policies, such that when they are violated, the policy violation is ranked higher than instruments with abnormal readings or any other pattern violation. An example of a policy violation can include: an application average response time exceeding 0.25 seconds; an availability gauge reading less than one; a request failure rate gauge reading greater than zero; any other situation as specified by a product administrator, or any combination thereof. If any one or more policies are violated, the one or more violated policies are ranked more probable than the instruments.

Recent changes to the computing environment may also be considered more probable than the instruments. For example, a server may have been provisioned or deprovisioned, a software or hardware upgrade or other component change may have been made, a control may have been changed, or any combination thereof. The temporal proximity of the change associated with the computing environment can be a clue as to the actual cause of the problem.

Regarding the instruments, many different methods can be used to rank which instrument is more probable than another instrument. In one embodiment, the degree of abnormality can be determined using one or more conventional or statistical techniques for one or more instruments. The degrees of abnormality may be normalized (or are already normalized) to allow for better comparison between the different instruments.

In another embodiment, the ranking can also include accessing relationship information between a first instrument and other instruments associated with the computing environment. The computing environment may include hundreds, thousands, or even more instruments. The significance and mathematical descriptions of the relationships between instruments may have already been determined, as previously described. In one embodiment, the first instrument can be a particular special-interest instrument for a particular application. The relationship information can be used to determine which of the other instruments associated with the computing environment are significant with respect to the particular special-interest instrument and to determine mathematical relationships between the particular special-interest instrument and its corresponding significant instruments. The relationship information can be retrieved from disk 290 or from the storage network 136. In another embodiment, the information can be provided by a product administrator, from configuration information (e.g., one or more configuration files), or obtained in another way. After reading the specification, skilled artisans will appreciate that many different techniques can be used to access the relationship information.

The method can optionally include applying a filter to retain a set of instruments consistent with one or more filtering criteria, at block 624. One or more filters can be based on nearly any one or more criteria and can be referred to as output filters. For example, the criteria used for output filters can specify the scope of retained instruments, such as only those instruments related to a cause (e.g., instruments where reading are unavailable, pattern violations, policy violations, etc.), aggregation level (host by host, host by tier, transaction types, application, etc.), component type (e.g., hardware or software service), hardware category (e.g., host, standalone network device, etc.) operating system (e.g., Linux™ brand, Solaris™ brand, Windows™ brand, AIX™ brand, HPUX™ brand, etc.), software service category (e.g., presentation, business logic, database, thin net solution software (e.g., Citrix™ brand), network, etc.), product category (Apache, WebLogic, Oracle™ brand, SQL server, DB2™ brand, WebSphere™ brand, ASP™ brand, COM+, .NET™ brand, Active Directory™ brand, Citrix™ brand, IIS™ brand, iPlanet™ brand, Cesura™ brand, etc.), other suitable division, or any combination thereof. The scope of the filter can be tailored by the product administrator to the needs or desires of the business.

In a particular embodiment, an application filter (also called a usage filter) can be used. Typically, the probable cause analysis is focused on a particular instrument, such as a special-interest instrument for the particular application. The filter can be used to remove, as potential causes, those instruments associated with the computing environment that do not significantly affect or are not significantly affected by the application when running within the computing environment. The filter can be applied earlier in the process than what is illustrated in FIG. 6. Thus, retaining the set of instruments that is used by the application can be performed before ranking the potential causes. The other output filters can be used in a similar fashion to retain only the instruments of interest. In another embodiment, more than one output filter could be used.

The method as described in FIG. 6 can be iterated for other special-interest instruments if desired. The special-interest instruments may or may not be abnormal. Also, the probable analysis can be extended to ordinary instruments. In one particular embodiment, part or all of the methods as described in FIGS. 4, 5, and 6 can be performed using the ordinary instruments along with one or more special-interest instruments. For example, CPU utilization at web server farm 133, which is an example of a logical instrument that may not be a special-interest instrument, can be analyzed.

The ability to precisely determine the cause may depend in part on the level of instrumentation associated with the computing environment 100. For example, if instrumentation is at a very high level, a probable cause may be at a functional level, for example, a problem with the web server farm 133. With more instrumentation, problems at lower levels may be detected, for example, at the actual web server, at the CPU within web server, or even a specific register within the CPU of the web server. Thus, as more instrumentation is available, the ability to more precisely detect the probable cause of a problem increases.

The methodology as described herein does not require that time be input as a variable. Thresholds do not need to be adjusted on a regular schedule. Rather, the normality or abnormality of each instrument reading can be determined when the reading is gathered. Therefore, the method can be an asynchronous process. Similarly, time may not be a variable used when filtering the data collected. Rather, a typical pattern can be any multivariate pattern that looks similar to a pattern in the product administrator-selected typical operating interval. The time of day or week over which a similar pattern is collected or even what time it is now may be irrelevant.

Based on data collected from instruments, such data can be associated with a pre-computed cluster with predetermined thresholds. Therefore, automatic thresholding can occur, but the automatic thresholding does not need to be updated based on a timed schedule.

The method described herein does not require that the data be formatted a particular way or pre-processed with sorting, etc. The method can allow for thresholds for abnormality to be updated as fresh instrument readings are obtained.

A sliding window for the analysis is not needed. In one embodiment, typical operating intervals do not need to change unless the product administrator approves of such a change and can keep determinations of normality or abnormal under the product administrator's control. The product administrator can add new data from a new interval of time to the existing typical operating intervals. After augmenting the data, from a new interval, the model used to carry out the method may be refreshed and establish new or updated thresholds for abnormality. Old patterns can still be retained, as a sliding window does not have to be used. In other words, the set of time intervals over which the first sets of readings are sampled can be augmented with additional time intervals of good operational data, and the mathematical model that captures the set of typical operating patterns does not lose consideration of the previously designated intervals of known good or believed to be good data. In a particular embodiment, the addition of such new operating data can be automatically captured. For example, if the operational data from a storefront website has not been collected over the holiday season, the operational data from Thanksgiving (latter part of November) to New Year's Day may be captured and designated as operational data for the holiday season. More granularity can be used, for example, data could be for only the last weekend before Christmas. In a particular embodiment, the operational data can be augmented with future time intervals of anticipated good data and the mathematical model can automatically update when the operational data from a future time interval becomes available.

The method described herein can be used for just a portion of the computing environment, rather than an environment as a whole. For example, the same or another instance of a software program that includes instructions to perform the methodology as described herein can be performed on the web server farm 133, the application server farm 134, the database server farm 135, the storage network 136, or another portion of the computing environment. Similarly, individual servers can be examined. After reading this specification, skilled artisans will appreciate that the systems and methods described herein are flexible and can be adapted to different levels within the computing environment hierarchy.

Many different aspects and embodiments are possible. Some of those aspects and embodiments are described below. After reading this specification, skilled artisans will appreciate that those aspects and embodiments are only illustrative and do not limit the scope of the present invention.

In one aspect, a method can be used to determine whether a business disruption associated with a computing environment has occurred. The method can include accessing an actual end-user response time, demand of the computing environment, and capacity of the computing environment. The method can also include determining whether the first end-user response time exceeds a threshold, wherein the threshold is a function of the demand and capacity.

In one embodiment of the first aspect, determining whether the actual end-user response time exceeds a threshold can include accessing first operating data associated with the computing environment. The first operating data can include first sets of readings from a first set of instruments associated with the computing environment, and the first set of instruments includes an end-user response time gauge and a load gauge. The method can also include separating the first operating data into different sets of clustered operating data, including a first set of clustered operating data. The method can further include accessing second operating data associated with the computing environment. The second operating data include a second set of readings from the first set of instruments, and the second set of readings includes the actual end-user response time. The method can still further include determining that the second operating data is closer to the first set of clustered operating data as compared to any other different set of clustered operating data, and determining whether the actual end-user response time from the second operating data is greater than a corresponding end-user response time from the first operating data.

In another embodiment of the first aspect, determining whether the actual end-user response time exceeds a threshold can include determining a predicted end-user response time using a predictive model, wherein inputs to the predictive model includes data associated at least with demand and capacity of the computing environment. The method can also include determining whether the actual end-user response time is greater than the predicted end-user response time. In still another embodiment, determining whether the actual end-user response time exceeds a threshold can include accessing a policy associated with a specified end-user response time, demand, and capacity; and determining whether the policy has been violated based at least in part on the actual end-user response time.

In a second aspect, a method of operating a computing environment including a plurality of instruments can include accessing first operating data associated with the computing environment. The first operating data include first sets of readings from a first set of instruments associated with the computing environment, and the plurality of instruments includes the first set of instruments. The method can also include separating the first operating data into different sets of clustered operating data, including a first set of clustered operating data. The method can further include accessing second operating data associated with the computing environment, wherein the second operating data include a second set of readings from the first set of instruments. The method can still further include determining that the second operating data is closer to the first set of clustered operating data as compared to any other different set of clustered operating data.

In one embodiment of the second aspect, the first sets of readings from the first set of instruments reflect when the computing environment is known or believed to be operating when in a typical state. In another embodiment, the method can further include adding additional operating data associated with a health of the computing environment to the first operating data after determining that the second operating data is closer to the first set of clustered operating data as compared to any other different set of clustered operating data, wherein substantially no data is removed from the first operating data at substantially a same time as adding the additional operating data.

In still another embodiment of the second aspect, the method can further include determining, for one or more instruments within the first set of instruments, a degree of abnormality associated with the one or more instruments within the first set of instruments, based on the first set of clustered operating data. The method can also include determining which of the one or more instruments has a reading within the second operating data that is beyond a threshold of abnormality for the one or more instruments. In a particular embodiment, the one or more instruments include a gauge for response time, request load, request failure rate, request throughput, or any combination thereof. In a more particular embodiment, the method can further include performing a probable cause analysis after determining which of the one or more instruments has the reading within the second operating data that is beyond the threshold.

In an even more particular embodiment of the second aspect, performing the probable cause analysis can include determining degrees of abnormality for at least two instruments within the plurality of instruments and ranking potential causes in order of likelihood based at least in part on the degrees of abnormality. In another even more particular embodiment, performing the probable cause analysis can include accessing relationship information associated with relationships between at least two of the plurality instruments associated with the computing environment, wherein the plurality of instruments includes at least one instrument outside of the first set of instruments, and ranking potential causes in order of likelihood based in part on the relationship information.

In a further more particular embodiment, the method can further include filtering potential causes based on a criterion, wherein at least some of the plurality of instruments affect an end-user response time. In yet a further more particular embodiment, the criterion includes which of the plurality of instruments are used by an application running within the computing environment, and wherein filtering potential causes can include performing statistical analysis on the other instruments associated with the computing environment to determine which of the other instruments are significantly affected when running the application within the computing environment, accessing a user-defined list that includes at least one of the other instruments; accessing configuration information associated with the computing environment, accessing network data regarding a flow, a stream, a connection and its utilization, or any combination thereof. In still another particular embodiment, performing the probable cause analysis can include accessing a predefined policy for the computing environment, determining that the predefined policy has been violated, and determining the probable cause based in part on the violation of the predefined policy.

In a further embodiment, the method can further include receiving a predetermined number for the different sets of clustered operating data before separating the first operating data. In still a further embodiment, the method can further include determining when a new operating pattern will occur in the future, and setting the computing environment to not generate alerts when data is being collected during a time period corresponding to the new operating pattern.

In a third aspect, a method of operating a computing environment including a plurality of instruments can include determining that a reading from at least one instrument within the plurality of instruments is abnormal, wherein determining is performed at least in part using a multivariate analysis involving at least two instruments within the plurality of instruments, and ranking potential causes of a problem in the computing environment in order of likelihood.

In one embodiment of the third aspect, the method can further include determining degrees of abnormality for at least two instruments within the plurality of instruments, wherein ranking the potential causes in order of likelihood includes ranking the potential causes based at least in part on the degrees of abnormality. In another embodiment, the method can further include accessing relationship information between a first instrument and other instruments associated with the computing environment, wherein ranking the potential causes in order of likelihood includes ranking the potential causes based at least in part on the relationships between the first and the other instruments. In still another embodiment, the method can further include retaining a set of instruments from the other instruments, wherein the set of instruments meet a criterion. In a particular embodiment, the criterion includes which of the plurality of instruments are used by an application running within the computing environment, and wherein retaining a set of instruments can include performing statistical analysis on the other instruments associated with the computing environment to determine which of the other instruments are significantly affected when running the application within the computing environment, accessing a user-defined list that includes at least one of the other instruments, accessing a configuration file that includes configuration information associated with the computing environment, accessing network data regarding a flow, a stream, a connection and its utilization, or any combination thereof.

In a further embodiment of the third aspect, ranking potential causes of the atypical state can include determining that a policy violation is a more probable cause than any pattern violation, determining that a change to the computing environment is a more probable cause than the pattern violation, or any combination thereof. In still a further embodiment, determining that an application is running within the computing environment in an atypical state includes determining that a first instrument has a reading that is beyond a threshold of abnormality. In yet another embodiment, determining that an application is runing within the computing environment in an atypical state includes determining that a first instrument has a reading that differs from a predicted value by more than a threshold amount.

In still another set of embodiments, data processing system readable media can include code that includes instructions for carrying out the methods described herein and may be used with the computing environment and its associated components (e.g., end-user devices). In yet another set of embodiments, the methods can be carried out by a system including hardware, software, or a combination thereof. The system can include or access the data processing readable media, or a combination thereof.

### EXAMPLES

The flexibility of the method and system can be further understood in the non-limiting examples described herein. The embodiments as further described in the following examples are meant to illustrate potential uses and implementations and do not limit the scope of the invention.

### Example 1

Example 1 demonstrates that by using the cluster analysis, problems encountered by an application running within a distributed computing environment can be detected more accurately than with a univariate analysis.

Data can be collected from a distributed computing environment using five special-interest instruments and 183 ordinary instruments. The five special-interest instruments can include three from one application (App1 Average Response Time or App1 RT, App1 Request Failure Rate or App1 RFR, App1 Request Load or App1 RL) and two from another application (App2 Average Response Time or App2 RT, App2 Request Load or App2 RL). The data can be collected to establish a typical operating pattern.

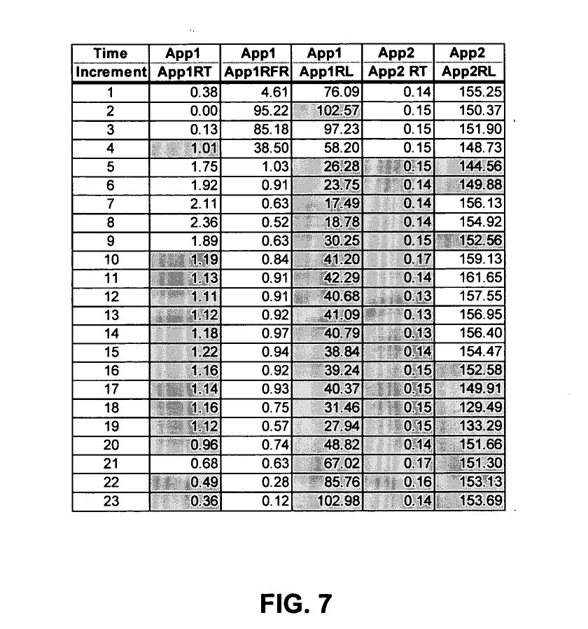

The distributed computing system can be run and collect operating data at a rate of one row of operating data per minute. For example, for approximately 2.5 days, approximately 3652 rows of readings can be collected. During that time, a database server, DELL1550SRV05, is intentionally made unavailable. Of those 3652 rows, 23 rows are collected during database server unavailability. FIG. 7 includes readings for the five special-interest instruments for the 23 rows. In FIG. 7, readings that are considered normal are shaded, and readings that are abnormal are not shaded (“unshaded”).

The first indication of trouble visible to the product administrator is that App1 RT, App1 RL, and App1 RFR all go into violation at the same time, per the unshaded readings in FIG. 7. Only the App1 RFR violation persists. Queued up requests continue to fail as they work their way through the data center. An App1 RFR greater than zero may be rare as compared to the typical operating pattern having good data.

Note that the first few rows of App1 RT are too low, and then the next few are too high, given the amount of load. Such information can be obtained by using the data from the good operating data because both abnormal-high and abnormal-low violations, with respect to the typical operating patterns can be determined. Failed requests are processed so quickly and potentially cause the App1 RT to be too low for the amount of load. This is a valid indication of a problem. By solely using instrument-by-instrument alerts, as used with a conventional univariate analysis, such abnormalities would be difficult, if not impossible, to detect.

### Example 2

Example 2 demonstrates that a multivariate analysis and probable cause analysis can be performed to detect problems encountered by an application running within a distributed computing environment and to provide a product administrator with more probable causes of the problem.

In one embodiment, approximately 3500 instruments, five of which are special-interest instruments and thousands of which are ordinary instruments could be eligible for probable cause analysis. In this example, the analysis is limited to 183 ordinary instruments due to restrictions in gathering the data. Similar to the prior example, a database server, Dell1550srv05, becomes unavailable.

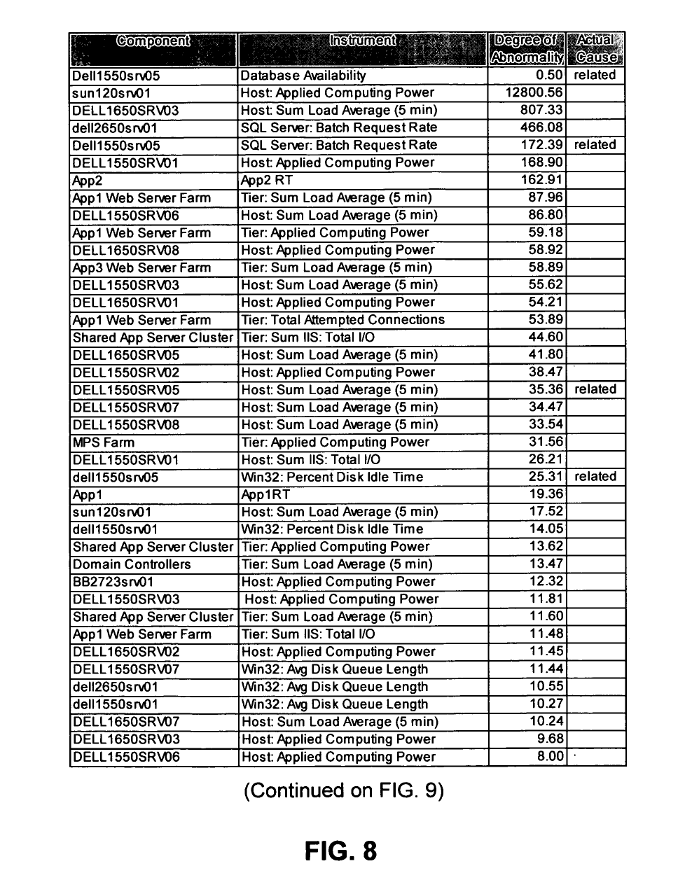

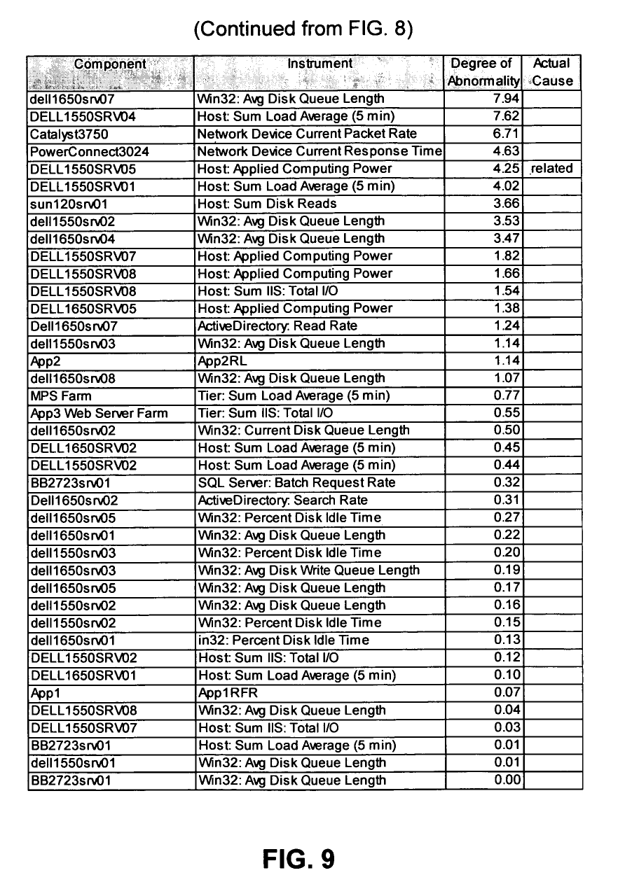

As with special-interest instrument abnormality, ordinary instrument abnormality occurs when an ordinary instrument reading was rarely or never observed in the good operating data under similar special-interest instrument behavior. A probable cause can be a concurrent instrument abnormality. The concurrency provides linkage between the instrument violation and the special-interest instrument violation to which it is a probable cause. Univariate analysis is not well suited to address concurrent pattern abnormality because it is focused on each instrument, not relationships between two or more different instruments. While the two abnormalities may or may not be actually related, the abnormal instruments can be sorted by their standardized distance from optimal centroid during cluster analysis to identify the instruments that are violating the typical operating pattern most egregiously. Various filters can be applied to the list of instruments, including an optional usage filter. In this example, one or more policy violations may be listed before any pattern violation by an instrument. Otherwise, the instruments may be listed by their degree of abnormality. The sorted list in FIGS. 8 and continued onto FIG. 9 is in order of abnormality without invoking a usage filter. Items closer to the top of FIG. 8 are more probable than items closer to the bottom of FIG. 9. Policy violations and instruments that are related to the actual cause, database failure on Dell1550srv05, are noted.

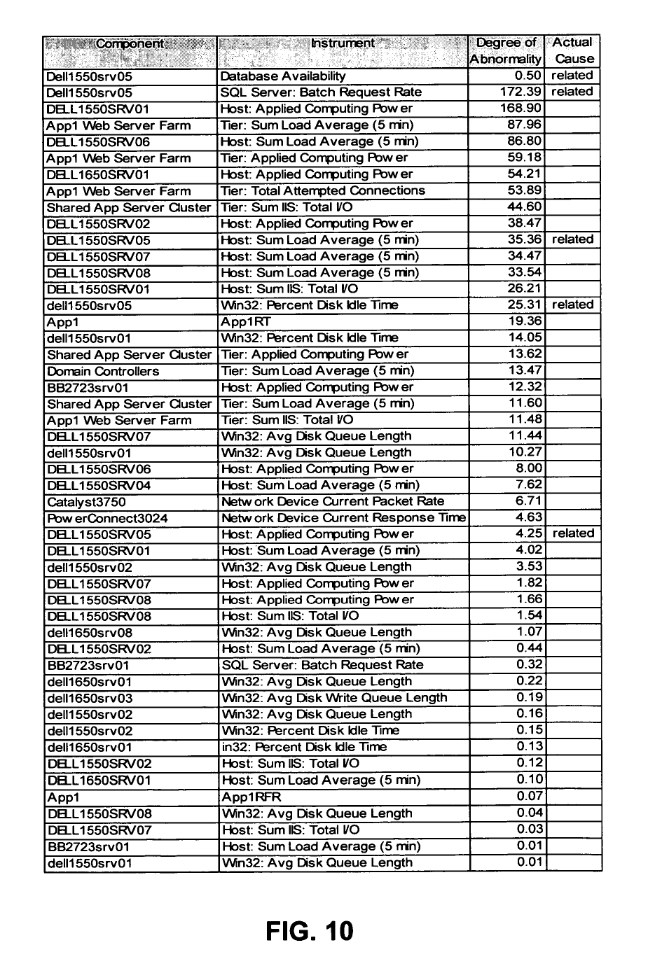

A usage filter can be used to focus attention in relevant places. The usage filter retains only those instruments that are significantly affected by or significantly affect the application where the problem is occurring. FIG. 10 includes a list after a usage filter is applied to the list as illustrated in FIGS. 8 and 9. With the usage filter, the list becomes shorter. Thus, identifying relevant probable causes of the problems can be achieved.

Note that not all of the activities described above in the general description or the examples are required, that a portion of a specific activity may not be required, and that one or more further activities may be performed in addition to those described. Still further, the order in which activities are listed are not necessarily the order in which they are performed. After reading this specification, skilled artisans will be capable of determining what activities can be used for their specific needs or desires.

Any one or more benefits, one or more other advantages, one or more solutions to one or more problems, or any combination thereof have been described above with regard to one or more specific embodiments. However, the benefit(s), advantage(s), solution(s) to problem(s), or any element(s) that may cause any benefit, advantage, or solution to occur or become more pronounced is not to be construed as a critical, required, or essential feature or element of any or all the claims.

The above-disclosed subject matter is to be considered illustrative, and not restrictive, and the appended claims are intended to cover all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of determining whether a business disruption associated with a computing environment has occurred, the method comprising:
accessing an actual end-user response time, demand of the computing environment, and capacity of the computing environment; and
determining whether the first end-user response time exceeds a threshold, wherein the threshold is a function of the demand and capacity.

2. The method of claim 1, wherein determining whether the actual end-user response time exceeds a threshold comprises:
accessing first operating data associated with the computing environment, wherein:
the first operating data include first sets of readings from a first set of instruments associated with the computing environment; and
the first set of instruments includes an end-user response time gauge and a load gauge;
separating the first operating data into different sets of clustered operating data, including a first set of clustered operating data;
accessing second operating data associated with the computing environment, wherein:
the second operating data include a second set of readings from the first set of instruments; and
the second set of readings includes the actual end-user response time;
determining that the second operating data is closer to the first set of clustered operating data as compared to any other different set of clustered operating data; and
determining whether the actual end-user response time from the second operating data is greater than a corresponding end-user response time from the first operating data.

3. The method of claim 1, wherein determining whether the actual end-user response time exceeds a threshold comprises:
determining a predicted end-user response time using a predictive model, wherein inputs to the predictive model includes data associated at least with demand and capacity of the computing environment; and
determining whether the actual end-user response time is greater than the predicted end-user response time.

4. The method of claim 1, wherein determining whether the actual end-user response time exceeds a threshold comprises:
accessing a policy associated with a specified end-user response time, demand, and capacity; and
determining whether the policy has been violated based at least in part on the actual end-user response time.

5. A system operable for carrying out the method of claim 1.

6. A method of operating a computing environment including a plurality of instruments comprising:
accessing first operating data associated with the computing environment, wherein:
the first operating data include first sets of readings from a first set of instruments associated with the computing environment; and
the plurality of instruments includes the first set of instruments;
separating the first operating data into different sets of clustered operating data, including a first set of clustered operating data;
accessing second operating data associated with the computing environment,
wherein the second operating data include a second set of readings from the first set of instruments; and
determining that the second operating data is closer to the first set of clustered operating data as compared to any other different set of clustered operating data.

7. The method of claim 6, wherein the first sets of readings from the first set of instruments reflect when the computing environment is known or believed to be operating when in a typical state.

8. The method of claim 6, further comprising adding additional operating data associated with a health of the computing environment to the first operating data after determining that the second operating data is closer to the first set of clustered operating data as compared to any other different set of clustered operating data, wherein substantially no data is removed from the first operating data at substantially a same time as adding the additional operating data.

9. The method of claim 6, further comprising:
determining, for one or more instruments within the first set of instruments, a degree of abnormality associated with the one or more instrument within the first set of instruments, based on the first set of clustered operating data; and
determining which of the one or more instruments has a reading within the second operating data that is beyond a threshold of abnormality for the one or more instruments.

10. The method of claim 9, wherein the one or more instruments include a gauge for response time, request load, request failure rate, request throughput, or any combination thereof.

11. The method of claim 10, further comprising performing a probable cause analysis after determining which of the one or more instruments has the reading within the second operating data that is beyond the threshold.

12. The method of claim 11, wherein performing the probable cause analysis comprises:
determining degrees of abnormality for at least two instruments within the plurality of instruments; and
ranking potential causes in order of likelihood based at least in part on the degrees of abnormality.

13. The method of claim 11, wherein performing the probable cause analysis comprises:
accessing relationship information associated with relationships between at least two of the plurality instruments associated with the computing environment, wherein the plurality of instruments includes at least one instrument outside of the first set of instruments; and
ranking potential causes in order of likelihood based in part on the relationship information.

14. The method of claim 13, further comprising filtering potential causes based on a criterion, wherein at least some of the plurality of instruments affect an end-user response time.

15. The method of claim 14, wherein the criterion includes which of the plurality of instruments are used by an application running within the computing environment, and wherein filtering potential causes comprises:
performing statistical analysis on the other instruments associated with the computing environment to determine which of the other instruments are significantly affected when running the application within the computing environment;
accessing a user-defined list that includes at least one of the other instruments;
accessing configuration information associated with the computing environment;
accessing network data regarding a flow, a stream, a connection and its utilization, or any combination thereof; or
any combination thereof.

16. The method of claim 11, wherein performing the probable cause analysis comprises:
accessing a predefined policy for the computing environment;
determining that the predefined policy has been violated; and
determining the probable cause based in part on the violation of the predefined policy.

17. The method of claim 6, further comprising receiving a predetermined number for the different sets of clustered operating data before separating the first operating data.

18. The method of claim 6, further comprising:
determining when a new operating pattern will occur in the future; and
setting the computing environment to not generate alerts when data is being collected during a time period corresponding to the new operating pattern.

19. A system operable for carrying out the method of claim 6.

20. A method of operating a computing environment including a plurality of instruments, the method comprising:
determining that a reading from at least one instrument within the plurality of instruments is abnormal, wherein determining is performed at least in part using a multivariate analysis involving at least two instruments within the plurality of instruments; and
ranking potential causes of a problem in the computing environment in order of likelihood.

21. The method of claim 20, further comprising determining degrees of abnormality for at least two instruments within the plurality of instruments, wherein ranking the potential causes in order of likelihood comprises ranking the potential causes based at least in part on the degrees of abnormality.

22. The method of claim 20, further comprising accessing relationship information between a first instrument and other instruments associated with the computing environment, wherein ranking the potential causes in order of likelihood comprises ranking the potential causes based at least in part on the relationships between the first and the other instruments.

23. The method of claim 20, further comprising retaining a set of instruments from the other instruments, wherein the set of instruments meet a criterion.

24. The method of claim 23, wherein the criterion includes which of the plurality of instruments are used by an application running within the computing environment, and wherein retaining a set of instruments comprises:
performing statistical analysis on the other instruments associated with the computing environment to determine which of the other instruments are significantly affected when running the application within the computing environment;
accessing a user-defined list that includes at least one of the other instruments;
accessing a configuration file that includes configuration information associated with the computing environment;
accessing network data regarding a flow, a stream, a connection and its utilization, or any combination thereof; or
any combination thereof.

25. The method of claim 20, wherein ranking potential causes of the atypical state comprises:
determining that a policy violation is a more probable cause than any pattern violation;
determining that a change to the computing environment is a more probable cause than the pattern violation; or
any combination thereof.

26. The method of claim 20, wherein determining that an application is running within the computing environment in an atypical state comprises determining that a first instrument has a reading that is beyond a threshold of abnormality.

27. The method of claim 20, wherein determining that an application is running within the computing environment in an atypical state comprises determining that a first instrument has a reading that differs from a predicted value by more than a threshold amount.

28. A system operable for carrying out the method of claim 20.

29. A data processing system readable medium having code embodied within the data processing system readable medium, the code comprising:
an instruction to access an actual end-user response time, demand of the computing environment, and capacity of the computing environment; and
an instruction to determine whether the first end-user response time exceeds a threshold, wherein the threshold is a function of the demand and capacity.

30. The data processing system readable medium of claim 29, wherein the instruction to determine whether the actual end-user response time exceeds a threshold comprises:
an instruction to access first operating data associated with the computing environment, wherein:
the first operating data include first sets of readings from a first set of instruments associated with the computing environment, wherein the first set of instruments includes an end-user response time gauge and a load gauge;
an instruction to separate the first operating data into different sets of clustered operating data, including a first set of clustered operating data;
an instruction to access second operating data associated with the computing environment, wherein the second operating data include a second set of readings from the first set of instruments, and the second set of readings includes the actual end-user response time;
an instruction to determine that the second operating data is closer to the first set of clustered operating data as compared to any other different set of clustered operating data; and
an instruction to determine whether the actual end-user response time from the second operating data is greater than a corresponding end-user response time from the first operating data.

31. The data processing system readable medium of claim 29, wherein the instruction to determine whether the actual end-user response time exceeds a threshold comprises:
an instruction to determine a predicted end-user response time using a predictive model, wherein inputs to the predictive model includes data associated at least with demand and capacity of the computing environment; and
an instruction to determine whether the actual end-user response time is greater than the predicted end-user response time.

32. The data processing system readable medium of claim 29, wherein the instruction to determine whether the actual end-user response time exceeds a threshold comprises:
an instruction to access a policy associated with a specified end-user response time, demand, and capacity; and
an instruction to determine whether the policy has been violated based at least in part on the actual end-user response time.

33. A data processing system readable medium having code embodied within the data processing system readable medium, the code comprising:
an instruction to access first operating data associated with the computing environment, wherein:
the first operating data include first sets of readings from instruments associated with the computing environment; and
the plurality of instruments includes the first set of instruments;
an instruction to separate the first operating data into different sets of clustered operating data, including a first set of clustered operating data;
an instruction to access second operating data associated with the computing environment, wherein the second operating data include a second set of readings from the first set of instruments; and
an instruction to determine that second operating data is closer to the first set of clustered operating data as compared to any different set of clustered operating data.

34. The data processing system readable medium of claim 33, wherein the first sets of readings from the instruments reflect when the computing environment is known or believed to be operating when in a typical state.

35. The data processing system readable medium of claim 33, wherein the code further comprises an instruction to add additional operating data associated with a health of the computing environment to the first operating data after determining that the second operating data is closer to the first set of clustered operating data as compared to any other different set of clustered operating data, wherein substantially no data is removed from the first operating data at substantially a same time as when the instruction to add is being executed.

36. The data processing system readable medium of claim 33, wherein the code further comprises:
an instruction to determine, for one or more instruments within the first set of instruments, a degree of abnormality associated with the one or more instrument within the first set of instruments, based on the first set of clustered operating data; and
an instruction to determine which of the one or more instruments has a reading within the second operating data that is beyond a threshold of abnormality for the one or more instruments.

37. The data processing system readable medium of claim 36, wherein the one or more instruments include a gauge for response time, request load, request failure rate, request throughput, or any combination thereof.

38. The data processing system readable medium of claim 37, wherein the code further comprises an instruction to execute a probable cause analysis after determining which of the one or more instruments has the reading within the second operating data that is beyond a threshold of abnormality.

39. The data processing system readable medium of claim 38, wherein the instruction to perform the probable cause analysis comprises:
an instruction to determine degrees of abnormality for at least two instruments within the plurality of instruments; and
an instruction to rank potential causes in order of likelihood based at least in part on the degrees of abnormality.

40. The data processing system readable medium of claim 38, wherein the instruction to execute the probable cause analysis comprises:
an instruction to access relationship information associated with relationships between at least two of the instruments associated with the computing environment, wherein the plurality of instruments includes at least one instrument outside of the first set of instruments; and
an instruction to rank potential causes in order of likelihood based in part on the relationship information.

41. The data processing system readable medium of claim 40, wherein the code further comprises an instruction to filter potential causes based on a criterion, wherein at least some of the plurality of instruments affect an end-user response time.

42. The data processing system readable medium of claim 41, wherein the criterion includes which of the plurality of instruments are used by an application running within the computing environment, and wherein the instruction to filter potential causes comprises an instruction to determine which of the plurality of instruments are used by the application by executing:
an instruction to perform statistical analysis on the other instruments associated with the computing environment to determine which of the other instruments are significantly affected when running the application within the computing environment;
an instruction to access a user-defined list that includes at least one of the other instruments;
an instruction to access configuration information associated with the computing environment;
an instruction to access network data regarding a flow, a stream, a connection and its utilization, or any combination thereof; or
any combination thereof.

43. The data processing system readable medium of claim 38, wherein an instruction to perform the probable cause analysis comprises:
an instruction to access a predefined policy for the computing system;
an instruction to determine that the predefined policy has been violated; and
an instruction to rank the policy violation as the probable cause.

44. The data processing system readable medium of claim 33, wherein the code further comprises an instruction to access a predetermined number for the different sets of clustered operating data before separating the first operating data.

45. The data processing system readable medium of claim 33, wherein the code further comprises:
an instruction to determine when a new operating pattern will occur in the future; and
an instruction to set the computing environment to not generate alerts when data is being collected during a time period corresponding to the new operating pattern.

46. A data processing system readable medium having code embodied within the data processing system readable medium, the code comprising:
an instruction to determine that a reading from at least one instrument within the plurality of instruments is abnormal, wherein determining is performed at least in part using a multivariate analysis involving at least two instruments within the plurality of instruments; and
an instruction to rank potential causes of a problem in order of likelihood.

47. The data processing system readable medium of claim 46, wherein the code further comprises an instruction to determine degrees of abnormality for at least two instruments within the plurality of instruments, wherein the instruction to rank the potential causes in order of likelihood comprises an instruction to rank the potential causes based at least in part on the degrees of abnormality.

48. The data processing system readable medium of claim 46, wherein the code further comprises an instruction to access relationship information between a first instrument and other instruments associated with the computing environment, wherein the instruction to rank the potential causes in order of likelihood comprises an instruction to rank the potential causes based at least in part on the relationships between the first and the other instruments.

49. The data processing system readable medium of claim 46, wherein the code further comprises an instruction to retain a set of instruments from the other instruments, wherein the set of instruments meet a criterion.

50. The data processing system readable medium of claim 49, wherein the criterion includes which of the plurality of instruments are used by an application running within the computing environment, and wherein an instruction to retain a set of instruments comprises:
an instruction to perform statistical analysis on the other instruments associated with the computing environment to determine which of the other instruments are significantly affected when running the application within the computing environment;
an instruction to access a user-defined list that includes at least one of the other instruments;
an instruction to access a configuration file that includes configuration information associated with the computing environment;
an instruction to access network data regarding a flow, a stream, a connection and its utilization, or any combination thereof; or
any combination thereof.

51. The data processing system readable medium of claim 46, wherein the instruction to rank potential causes of the atypical state comprises:
an instruction to determine that a policy violation is a more probable cause than any gauge associated with the computing environment;
an instruction to determine that a change to the computing environment is a more probable cause than the any gauge associated with the computing environment; or
any combination thereof.

52. The data processing system readable medium of claim 46, wherein the instruction to determine that an application is running within the computing environment in an atypical state comprises an instruction to determine that a first instrument has a reading that is outside a predetermined range.

53. The data processing system readable medium of claim 46, wherein an instruction to determine that an application is running within the computing environment in an atypical state comprises an instruction to determine that a first instrument has a reading that differs from a predicted value by more than a threshold amount.
